(19) United States
(12) Patent Application Publication
(10) Pub. No.: US 2022/0184812 A1
(43) Pub. Date: Jun. 16, 2022

(54) Robot Gripper, and Method for Operating a Robot Gripper

(71) Applicant: FRANKA EMIKA GMBH, München (DE)

(72) Inventors: Andreas Spenninger, Karlsfeld (DE); Tim Rokahr, München (DE)

(21) Appl. No.: 17/439,936

(22) PCT Filed: Mar. 19, 2020
(86) PCT No.: PCT/EP2020/057544

§ 371 Date: Sep. 16, 2021

(30) Foreign Application Priority Data
Mar. 27, 2019 (DE) 10 2019 107 851.2

(51) Int. Cl. B25J 9/16; B25J 13/08; B25J 15/02

(52) U.S. Cl. CPC B25J 9/1676; B25J 13/085; G05B 2219/40269; B25J 13/088; G05B 2219/50391; B25J 15/0253

(57) ABSTRACT

A robot gripper includes: a drive unit to drive a powertrain with active elements, wherein each element has a working region arranged in a body-fixed manner relative to the robot gripper, a respective element being moveable in and capable of reaching the working region; a control unit to control the drive unit; and a sensor system connected to the control unit to ascertain forces/moments applied externally to individual elements, the control unit configured such that collision monitoring is capable of being carried out for the elements, and when a collision is detected for an element, the drive unit is actuated according to a specified operation, including: providing a defined region within the working region for the elements, and collision monitoring for the elements only when the elements are located outside the assigned region, and deactivating collision monitoring when the elements are located at least partly within the assigned region.

### CROSS-REFERENCE TO RELATED APPLICATIONS

The present application is the U.S. National Phase of PCT/EP2020/057544, filed on 19 Mar. 2020, which claims priority to German Patent Application No. 10 2019 107 851.2, filed on 27 Mar. 2019, the entire contents of which are incorporated herein by reference.

### BACKGROUND

### Field

The invention relates to a robot gripper and to a method for operating a robot gripper.

### Related Art

Robot grippers (also referred to as “grippers” or “gripping system” or “effector” or “end effector”) are known in the prior art. Robot grippers are typically arranged on the distal end of robot manipulators and perform tasks such as gripping and/or holding objects/tools.

A robot gripper typically includes a drive unit, a powertrain (also referred to as: kinematic system), which moves active elements, a mechanical interface for the detachable fixed connection of the robot gripper, for example, to a robot manipulator, an energy interface for supplying energy necessary for the operation of the robot gripper, as well as a control signal interface for supplying control signals (for example, from a central robot control unit).

Active elements are elements of the robot gripper which are in direct contact with an object when gripping and holding the object, and in the process can exert a gripping force on the object. There are various possibilities for how a robot gripper can hold an object. Here, a distinction is made, for example, between different active matings: force mating, shape mating, substance mating. Moreover, multiple forms of the active elements themselves exist, for example, in the form of gripper jaws (in a parallel jaw gripper) or multi-member fingers (in an artificial hand).

The drive unit generates the kinetic energy necessary for the gripping or holding process. The drive unit drives the powertrain and thus generates corresponding movements of the active elements. Thereby, the opening, closing, and holding of an object by the robot gripper is possible.

The powertrain is used for transmitting the kinetic energy generated by the drive unit to the active elements. It thus converts a movement of the drive unit into a drive movement of the robot gripper, i.e., into a corresponding movement of the active elements.

### SUMMARY

The aim of the invention is to provide a robot gripper which enables an operation with improved safety.

The invention results from the features of the independent claims. Advantageous developments and embodiments are the subject matter of the dependent claims. Additional features, application possibilities and advantages of the invention result from the following description as well as from the explanation of embodiment examples of the invention, which are represented in the figures.

A first aspect of the invention relates to a method for operating a robot gripper, wherein the robot gripper includes: at least one drive unit AE for driving a powertrain AS with a number N of active elements WEₙ, wherein the active elements WEₙ each have a working region ABₙ which is arranged in a body-fixed manner relative to the robot gripper, in which working region the respective active elements WEₙ can be moved, and which working region can be reached by them;

a control unit for controlling the at least one drive unit AE, and a sensor system which is connected to the control unit for ascertaining forces/moments F_{ext,WEn}(t), where n=1, 2, . . . , N and N≥1, which are applied externally to the individual active elements WEₙ; wherein the control unit is designed and configured such that a collision monitoring can be carried out for the active elements WEₙ, and in the event of a detected collision for an active element Wₙ, the drive unit AE is actuated according to a specified operation, having the following steps: providing in each case a region Bₙ within the respective working region ABₙ for the active elements WEₙ and carrying out the collision monitoring for the active elements WEₙ only when the respective active elements WEₙ are located outside of the region Bₙ, and deactivating the collision monitoring for the active elements WEₙ when the respective active elements WEₙ are located at least partly within the assigned region Bₙ.

In the present case, the drive unit AE converts energy provided by the robot gripper (for example, pneumatic energy, hydraulic energy or electric energy) into a mechanical energy, i.e., into a movement. This movement is advantageously a translational and/or rotational movement. Advantageously, the drive unit is an electric motor which converts the provided electrical energy (potential U, current I) into a mechanical rotation. Depending on the application, other drive units are naturally also suitable, such as, for example, a hydraulic motor or a pneumatic motor for driving the powertrain. Advantageously, the drive unit drives multiple active elements WEₙ, in particular, two active elements WE_{n=1,2}. Advantageously, the robot gripper has multiple drive units, each driving one or more active elements WEₙ. The drive unit AE can, in particular, include a transmission for speed reduction or speed increase of a rotational movement.

The powertrain AS (also referred to as kinematic system) transmits the mechanical movement generated by the drive unit AE to one or more active elements WEₙ, so that they move correspondingly. For the mechanical implementation of the powertrain AS in a robot gripper, a plurality of implementations are known in the prior art. Particularly advantageously, the powertrain AS includes a belt, in particular, a toothed belt.

The working regions ABₙ of the active elements WEₙ each indicate a region which is arranged in a body-fixed manner relative to the robot gripper, in which the active elements WEₙ can be moved and which can be reached by them. The working regions ABₙ are thus defined in particular by the region which is spanned between the active elements WEₙ when the active elements WEₙ are open to the maximum. Since the working regions ABₙ are defined in a body-fixed manner relative to the robot gripper, the working regions ABₙ always remain identical independently of the position and orientation of the robot gripper.

According to the invention, the robot gripper has a sensor system for ascertaining forces/moments F_{ext,WEn}(t), where n=1, 2, . . . , N and N≥1, which are applied externally to the individual active elements WEₙ. Forces/moments applied on other parts of the robot gripper, for example, on a housing of the robot gripper, are therefore not acquired by this sensor system.

In a particularly advantageous development of the proposed method, using a position sensor, a position q_{AE} of the drive unit AE, and/or, using a position sensor, a position q_{AS} of the powertrain, and/or, using a speed sensor, a drive unit speed q_{AE} of the drive unit AE, and/or, using a speed sensor, a powertrain speed q_{As} of the powertrain AS, and/or, using a torque sensor, a torque τ_{AE} of the drive unit of the AE, and/or, using a torque sensor, a torque τ_{AS} in the powertrain AS, and/or, using a current sensor, a motor current I_{M} of an electric motor of the drive unit AE is/are determined.

Advantageously, no sensors are arranged on the active elements WEₙ. As a result, a corresponding cable connection to sensors on the active elements WEₙ is omitted. The active elements WEₙ are also advantageously exchangeable. Thus, advantageously, different types of active elements WEₙ can be connected to the powertrain AS, for example, in order to enable different active matings such as force mating, shape mating, substance mating during the gripping or holding.

The provision of the regions Bₙ within the working regions ABₙ can occur, for example, by corresponding inputs on the control unit, by reading a corresponding data memory of the control unit, by data transmission to the control unit via a data interface of the robot gripper, by a manual or automated “teach-in” process on the robot gripper after subsequent storing in a data memory of the control unit.

According to the invention, the control unit is designed and configured in such a manner that a collision monitoring for the active elements WEₙ is carried out only when the respective active elements WEₙ are located outside of the assigned regions Bₙ, and deactivating of the collision monitoring for the active elements WEₙ is carried out only when the respective active elements WEₙ are located at least partly within the respective assigned regions Bₙ.

The regions Bₙ are advantageously defined depending on an external geometry AG of an object to be gripped. Here, the external geometry AG can be defined, for example, in the case of a spherical object, by the diameter of the object. Here, the regions Bₙ are advantageously selected/defined in such a manner that the regions Bₙ include the external geometry AG (the edge/the surface of the object) of the object to be gripped, as well as a difference region ΔBₙ adjoining it externally: Bₙ=AG+ΔBₙ. Here, the sizes of the different region ΔBₙ are selected depending on the task definition, the safety standards to be applied (for example, jamming protection) and/or the sensitivity/rupture strength of the object to be gripped.

When carrying out the method, an objective of which is to grip an object, the collision monitoring/collision detection is accordingly carried out only outside of the regions Bₙ, i.e., outside of a zone (difference region ΔBₙ) around an object which is optimally positioned for gripping. Within this zone, in this example, the collision monitoring/collision detection is deactivated.

Advantageously, the working regions ABₙ are each a three-dimensional or a two-dimensional or a one-dimensional region. Advantageously, the regions Bₙ are each a three-dimensional or a two-dimensional or a one-dimensional region.

In a particularly preferable development of the proposed method, the robot gripper is designed as a parallel jaw gripper with two active elements WE_{n=1,2}, wherein a common working region AB and a common region B are defined by spacing ranges of the active elements WE_{n=1,2}. The working region AB is advantageously defined as the spacing range from a minimum spacing A_{MIN} to a maximum spacing A_{MAX}, which the active elements WE_{n=1,2} can assume with respect to one another. Depending on the task definition, the region B of this development is correspondingly specified by a maximum spacing limit value A_{B} and thus covers all spacings A from A_{MIN} to the spacing A_{B}.

Thus, the region B is defined by the spacings A of the active elements WE_{n=1,2} with respect to one another, for which: A_{MIN}≤A<A_{B} or A_{MIN}≤A≤A_{B} and A_{B}<A_{MAX}. In this development, a collision monitoring for the active elements WE_{n=1,2} is carried out only when the active elements WE_{n=1,2} have a spacing A for which: A>A_{B} or A≥A_{B}. Particularly preferably, the active elements (gripper jaws) of the parallel jaw gripper have no sensors.

The activation or deactivation of the collision monitoring according to the method, depending on a current position of the active elements WEₙ and depending on the defined regions Bₙ, occurs in principle independently of whether an object is arranged in such a manner relative to the robot gripper that it can also be gripped by the robot gripper, i.e., even if no object is arranged between the active elements WEₙ, a collision monitoring for the active elements WEₙ is carried out only when the respective active elements WEₙ are located outside of the assigned region Bₙ, and the collision monitoring for the active elements WEₙ is deactivated when the respective active elements WEₙ are located at least partly within the assigned region Bₙ.

An advantageous development of the robot gripper is characterized in that the robot gripper has a sensor, by which a presence or absence of an object in a gripping region of the robot gripper can be acquired, i.e., in that the sensor acquires that an object is arranged in such a manner that it can currently also be gripped by the robot gripper. If an object in the gripping region is ascertained by this sensor, then the collision monitoring for the active elements WEₙ is deactivated if they are located at least partly within the specified regions Bₙ. If no object in the gripping region is ascertained by this sensor, then advantageously no deactivation of the collision monitoring within the regions Bₙ occurs. In this case, the collision monitoring is carried out in the entire working region of the robot gripper.

The sensor for ascertaining an object in the gripping region of the robot gripper advantageously is, for example, a camera sensor, an ultrasound sensor, a laser sensor, an infrared sensor, a capacitive sensor, an inductive sensor, a microwave sensor, or a combination thereof.

An advantageous development of the proposed method is characterized in that the collision monitoring occurs on the basis of a specified dynamic model of the robot gripper. The dynamic model is a mathematical model which enables simulating the components of the robot gripper and their dynamic interactions. The control unit for closed loop and open loop control of the drive unit is in particular based on the dynamic model.

Advantageously, the collision monitoring for the active elements WEₙ occurs using a disturbance variable observer, in particular a performance observer or a pulse observer or a speed observer or an acceleration observer. Advantageously, for the collision monitoring, one or more of the measured variables: q_{AE}, q_{AS}, \dot{q}_{AE}, \ddot{q}_{AE}, \dot{q}_{AS}, \ddot{q}_{AS}, τ_{AE}, τ_{AS}, Iₘ are used. Here, the variables: \dot{q}_{AE}, \ddot{q}_{AE} and \dot{q}_{AS}, \ddot{q}_{AS}, respectively, can also be ascertained on the basis of corresponding time derivatives from the variables: q_{AE} and q_{AS}, respectively.

Advantageously, the collision monitoring occurs on the basis of a comparison of a target position and an actual position for q_{AE}, q_{AS}.

According to a development of the proposed method, the operation is selected from the following possibilities of a non-comprehensive list:
stopping the drive unit AE,
actuating the drive unit AE for gravity compensation,
actuating the drive unit AE for friction compensation,
actuating the drive unit AE in such a manner that a controlled continuous moving apart of the active elements WEₙ occurs, and
actuating the drive unit AE in such a manner that a reflex-like moving apart of the active elements WEₙ occurs.

Advantageously, defining the regions Bₙ within the working regions ABₙ occurs by a manual or automated teach-in process on the robot gripper. Advantageously, the teach-in process includes the following steps:
gripping an object in such a manner that each of the active elements WEₙ mechanically contacts the object, wherein the region enclosed in the process by the active elements WEₙ defines the regions AGₙ,
ascertaining the regions Bₙ, in that the regions AGₙ are widened outwardly by specified delta regions ΔBₙ, so that: Bₙ=AGₙ+ΔBₙ, and
storing Bₙ.

Storing Bₙ preferably occurs on a memory unit of the robot gripper.

By an appropriate selection of the regions Bₙ, in particular, jamming risks during the operation of the gripper in collaboration with a human, in particular, during an automatically performed gripping process of the robot gripper, are prevented or at least considerably reduced.

For example, if a sphere having a diameter of 5 cm (AG=5 cm) is to be gripped by a parallel jaw gripper, then, for the two gripper jaws, a common region B=AG+ΔB is advantageously defined by a spacing of the gripper jaws of 5.5 cm. Thereby, in the case of a central arrangement of the sphere between the gripper jaws, 2.5 mm (=ΔB/2) remain on each side of the sphere, before a collision monitoring during a further movement toward one another of the gripper jaws is deactivated. The 2.5 mm on each side of the sphere advantageously are measured in such a way that no human finger fits between gripper jaw and sphere.

The proposed method thus improves, in particular, the safety during a collaboration between robot gripper and an operator.

The robot gripper, to the extent that it is connected to a manipulator of a robot, can receive control commands from a central control unit of the robot. These control commands are transmitted to the control unit of the robot gripper. The control unit of the robot gripper converts these control commands and in principle actuates the drive unit correspondingly, wherein the collision monitoring according to the invention as well as the activation or respectively deactivation of the collision monitoring according to the invention are carried out locally on the control unit of the robot gripper. Advantageously, for the active elements WEₙ, collisions as detected are transmitted by the control unit of the robot gripper to a central control unit of the robot.

An additional aspect of the invention relates to a robot gripper including: at least one drive unit AE for driving a powertrain AS with a number N of active elements WEₙ, wherein the active elements WEₙ each have working regions ABₙ, which are arranged in a body-fixed manner relative to the robot gripper, in which the active elements WEₙ can each be moved, and which can be reached by them; a control unit for closed loop and open loop control of the at least one drive unit AE; and a sensor system connected to the control unit for ascertaining forces/moments F_{ext,WEn}(t), where n=1, 2, . . . , N and N≥1, which are applied externally to the individual active elements WEₙ; wherein the control unit is designed and configured in such a manner that, for the active elements WEₙ, a collision monitoring can be carried out; the collision monitoring for the active elements WEₙ is carried out only when the respective active elements WEₙ are located outside of a specified assigned region Bₙ located within the working region ABₙ; the collision monitoring for the active elements WEₙ is deactivated when the respective active elements WEₙ are located at least partly within the assigned region Bₙ; and if for an active element WEₙ a collision is detected, the drive unit is actuated according to a specified operation.

The drive unit AE is advantageously an electric motor or a hydraulic actuator or a pneumatic actuator. The drive unit AE can additionally include a transmission unit.

Advantageously, the drive regions ABₙ are each a three-dimensional or a two-dimensional or a one-dimensional region. Advantageously, the regions Bₙ are each a three-dimensional or a two-dimensional or a one-dimensional region.

In a particularly preferred development, the robot gripper is designed as a parallel jaw gripper with two active elements WE_{n=1,2}, wherein a common working region AB and a common region B are defined by spacing ranges of the active elements WE_{n=1,2}. The working region AB is advantageously defined as the spacing range from a minimum spacing A_{MIN} to a maximum spacing A_{MAX}, which the active elements WE_{n=1,2} can assume with respect to one another. Depending on the task definition, the region B of this development is correspondingly specified by a maximum spacing limit value A_{B} and thus covers all spacings A from A_{MIN} to the spacing AB_{B}.

Thus, the region B is defined by the spacings A of the active elements WE_{n=1,2} with respect to one another, for which: A_{MIN}≤A<A_{B} or A_{MIN}≤A≤A_{B} and A_{B}<A_{MAX}. In this development, a collision monitoring for the active elements WE_{n=1,2} is carried out only when the active elements WE_{n=1,2} have a spacing A for which: A>A_{B} or A≥A_{B}. Particularly preferably, the active elements (gripper jaws) of the parallel jaw gripper have no sensors.

In an advantageous development of the robot gripper, the sensor system has one or more of the following sensors: a position sensor for ascertaining a position q_{AE} of the drive unit AE and/or a position sensor for ascertaining a position q_{AS} of the powertrain AS and/or a speed sensor for ascertaining a drive unit speed \dot{q}_{AE} of the drive unit AE and/or a speed sensor for ascertaining a powertrain speed \dot{q}_{AS} of the powertrain AS and/or a torque sensor for ascertaining a torque τ_{AE} of the drive unit AE and/or a torque sensor for ascertaining a torque τ_{AS} in the powertrain AS and/or a current sensor for ascertaining the motor current I_{M} of an electric motor of the drive unit AE.

In an advantageous development of the proposed robot gripper, the control unit is designed and configured in such a manner that the collision monitoring occurs on the basis of a specified dynamic model of the robot gripper.

Advantageously, the control unit is designed and configured in such a manner that the collision monitoring occurs using a disturbance variable observer, in particular by a performance observer or a pulse observer or a speed observer or an acceleration observer.

Advantageously, for the collision monitoring, one or more of the measured variables: q_{AE}, q_{AS}, \dot{q}_{AE}, \ddot{q}_{AE}, \dot{q}_{AS}, \ddot{q}_{AS}, τ_{AE}, τ_{AS}, I_{M} are used. Here, the variables: \dot{q}_{AE}, \ddot{q}_{AE} and \dot{q}_{AS}, \ddot{q}_{AS}, respectively, can also be ascertained on the basis of corresponding time derivatives from the variables: q_{AE} and q_{AS}, respectively.

An advantageous development of the robot gripper is characterized in that the drive unit AE is a motor which is coupled via a transmission to the powertrain AS and in that a torque sensor for ascertaining a torque τ_{AS} in the powertrain AS is arranged between the transmission and the powertrain. The motor is advantageously an electric motor.

Advantageously, the control unit is designed and configured in such a manner that the operation is selected from the following possibilities of a non-comprehensive list:
stopping the drive unit AE,
actuating the drive unit AE for gravity compensation,
actuating the drive unit AE for friction compensation,
actuating the drive unit AE in such a manner that a controlled continuous moving apart from one another of the active elements WEₙ occurs, and
actuating the drive unit AE in such a manner that a reflex-like moving apart of the active elements WEₙ occurs.

Advantageously, the robot gripper has a housing, in which at least the drive unit AE and the control unit are integrated. The control unit advantageously includes a processor, a memory unit, as well as an interface for the specification of target control variables, for example, of a central computer for controlling a robot, to which the robot gripper is connected.

Finally, the invention relates to a robot or humanoid with a robot gripper, as described above.

Additional advantages, features and details result from the following description in which at least one embodiment example is described in detail, optionally in reference to the drawings. Identical, similar and/or functionally equivalent parts are provided with identical reference numerals.

### BRIEF DESCRIPTION OF THE DRAWINGS

In the drawings:

FIG. 1 is a highly schematic method sequence; and

FIG. 2 is a highly schematic above design of a proposed robot gripper.

### DETAILED DESCRIPTION

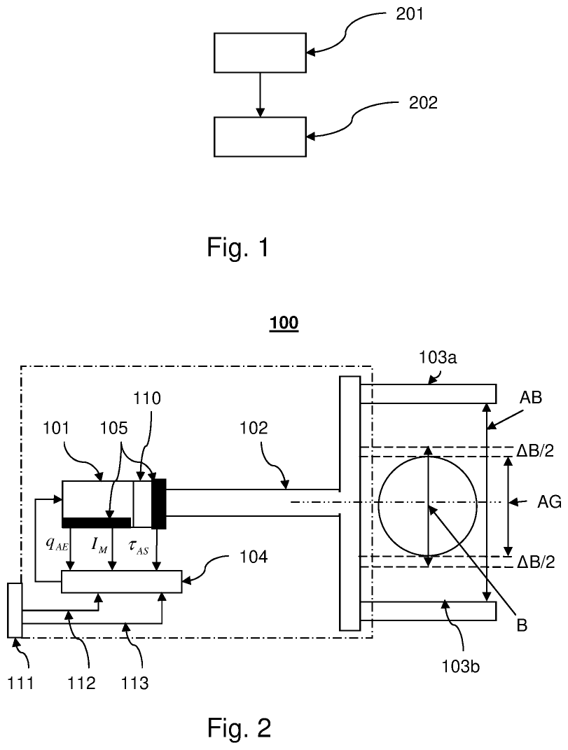

FIG. 1 shows a highly schematic sequence of a method for operating a robot gripper, wherein the robot gripper includes: at least one drive unit AE for driving a powertrain AS with a number N of active elements WEₙ, wherein the active elements WEₙ each have a working region arranged in a body-fixed manner relative to the robot gripper, in which the active elements WEₙ are movable and can be reached by them, a control unit for controlling the drive unit AE, and a sensor system connected to the sensor unit for ascertaining forces/moments F_{ext,WEn}(t), where n=1, 2, . . . , N and N≥1, which are applied externally to the individual active elements WEₙ.

The control unit is designed and configured in such a manner that, for the active elements WEₙ, a collision monitoring can be carried out autonomously and locally (i.e., without requiring an external control unit and/or an external processor), and in such a way that, when a collision is detected for an active element WEₙ, the drive unit is autonomously and locally actuated according to a specified operation.

The method includes the following steps which are carried out during the operation of the robot gripper, in particular, during the gripping of an object by the robot gripper. In a first step 201, for the active elements WEₙ, in each case a provision of a defined region Bₙ within the assigned working region ABₙ occurs.

During the actuation of the robot gripper for carrying out a gripping task, for example, controlled by an external central control unit of a robot, to which the robot gripper is connected, in step 202, an autonomous carrying out of the collision monitoring by the control unit of the robot gripper for the active elements WEₙ always occurs when the respective active elements WEₙ are located outside the region B, and a deactivation of the collision monitoring for the active elements WEₙ always occurs when the respective active elements WEₙ are located at least partly within the region Bₙ

Advantageously, the control unit of the robot gripper generates a collision signal when, for one of the active elements WEₙ, a collision is detected. Advantageously, the control unit of the robot gripper generates a deactivation signal when the collision monitoring for an active element WEₙ is deactivated. Advantageously, the robot gripper provides the collision signal and/or the deactivation signal to an interface, so that the signals can be transmitted to external control units.

In an embodiment of the proposed method, the collision monitoring for all active elements WEₙ is deactivated when at least one active element WEₙ is located at least partly within the assigned region Bₙ.

FIG. 2 shows a highly schematic design of a proposed robot gripper 100 which is implemented as parallel jaw gripper. The robot gripper 100 includes: a drive unit 101 which in the present case is formed as an electric motor with a downstream transmission 110 and which is used for driving a powertrain 102 with a number N=2 of active elements WE_{n=1,2} 103 (also referred to as: gripper jaws). The drive unit 101 drives the active elements WE_{n=1,2} 103 via the powertrain 102 in such a manner that they move either toward one another or apart from one another and thus the spacing A of the active elements WE_{n=1,2} 103 changes accordingly.

The two active elements WE_{n=1,2} 103 have a common working region AB arranged in a body-fixed manner relative to the robot gripper, in which the active elements WE_{n=1,2} 103 can be moved or which they can assume. In the present case, the working region AB is composed of a first working region ABₙ₌₁ of the upper gripper jaw 103a represented in FIG. 2, which reaches from the represented position A_{MAX,n=1} to a center (dash-dot-dot-line), and of a second working region ABₙ₌₂ of the lower gripper jaw 103b represented in FIG. 2, which reaches from the represented position A_{MAX,n=2} to the center (dash-dot-dot line).

Thus, in the present case, the composed working region AB of the parallel jaw gripper corresponds to all spacings A of the active elements WE_{n=1,2} 103 from A=0 (minimum spacing of the active elements WE_{n=1,2}) up to and including the maximum spacing A_{MAX}=|A_{MAX,n=1}−A_{MAX,n=2}|, which the active elements WE_{n=1,2} 103 can assume with respect to one another (marked AB in FIG. 2).

The parallel jaw gripper moreover has a control unit 104 for controlling the drive unit 101 and a sensor system 105 connected to the control unit 104 for ascertaining forces/moments F_{ext,WEn}(t), where n=1, 2, . . . , N and N≥1, which are applied externally to the individual active elements WE_{n=1,2}.

In the present case, the sensor system 105 includes a position sensor for ascertaining a motor position q_{AE} of the electric motor, a current sensor for ascertaining a motor current I_{AE} of the electric motor, as well as a torque sensor connected between the transmission 110 and the powertrain 102 for ascertaining the torque τ_{AS}. The measurement variables q_{AE}, I_{AE} and τ_{AS} are provided to the control unit 104.

Moreover, the parallel jaw gripper 100 has an interface 111 for electrical energy, as well as a control signal of an external control unit. The interface 111 is connected to the control unit 104 by at least one signal line 112 and at least one electric line 113.

If the parallel jaw gripper 100 is connected, for example, as effector, to a manipulator of a robot, then, via the interface 111, for example, control signals are provided to a central control unit of the robot, as well as energy for the parallel jaw gripper 100.

The control unit 104 is designed and configured in such a manner that, for the active elements WE_{n=1,2} 103, a collision monitoring can be carried out; the collision monitoring for the active elements WE_{n=1,2} 103 is carried out only when the respective active elements W_{n=1,2} 103 are located outside of a specified region B located within the working region AB; the collision monitoring for the active elements WE_{n=1,2} 103 is deactivated when the respective active elements WE_{n=1,2} 103 are located at least partly within the region B, and if, for an active element WE_{n=1,2}, a collision is detected, the drive unit 101 is actuated according to a specified operation.

This collision monitoring is in principle carried out independently of control commands, for example, an external robot malfunction.

The region B, i.e., the region in which the collision monitoring according to the invention is deactivated, in the present case is specified depending on the task definition correspondingly by a spacing limit value A_{B}, wherein the region B is defined by a spacing A of the active elements WE_{n=1,2} for which: A<A_{B} or A≤A_{B} and A_{B}<A_{MAX}. In this development, a collision monitoring for the active elements WE_{n=1,2} is only carried out if the active elements WE_{n=1,2} have a spacing > or ≥A_{B}. Particularly preferably, the active elements (gripper jaws) of the parallel jaw gripper have no sensors.

In FIG. 2, the above indicated regions are illustrated for a situation in which a sphere (in cross section) is arranged centrally between the gripper jaws 103a, 103b, wherein the gripper jaws 103a, 103b in each case are located in the position of their maximum displacement, i.e., their maximum spacing. The represented maximum spacing of the gripper jaws defines the working region AB. The region B located within the working region AB indicates the region in which a collision monitoring is deactivated. In the present case, the region B is defined by the diameter D=AG of the sphere, as well as by a safety zone ΔB/2 on both sides of the sphere.

If, during the gripping of the sphere, wherein the gripper jaws are moved toward one another from the position shown, external forces/moments are exerted on the gripper jaws, then a corresponding collision is detected if the gripper jaws in each case are located outside the region B. The detected collision leads to a specified operation, in particular, to a stopping of the drive unit. Moreover, a collision signal is provided at the interface 111 for transmission to an external control unit.

The collision monitoring in the control unit 104 occurs on the basis of a specified dynamic model of the parallel jaw gripper 100. Moreover, the collision monitoring in the control unit 104 occurs using a disturbance variable observer.

### LIST OF REFERENCE NUMERALS

100 Robot gripper

101 Drive unit

102 Powertrain

103 Active elements WEₙ

104 Control unit

105 Sensor system

110 Transmission

111 Interface for electrical energy and control signal of an external control unit

112 Control signal line

113 Electrical energy line

201, 202 Method steps

1. A method of operating a robot gripper, wherein the robot gripper comprises:
at least one drive unit AE to drive a powertrain AS with a number N of active elements WEₙ wherein each active element WEₙ has a working region ABₙ arranged in a body-fixed manner relative to the robot gripper, a respective active element WEₙ being moveable in and capable of reaching the working region;
a control unit to control the at least one drive unit AE; and
a sensor system connected to the control unit to ascertain forces/moments F_{ext,WEn}(t), where n=1, 2, . . . , N and N≥1, applied externally to individual active elements WEₙ;
wherein the control unit is designed and configured such that a collision monitoring is capable of being carried out for the active elements WEₙ, and that in an event of a detected collision event for an active element WEₙ, the drive unit AE is actuated according to a specified operation, the method comprising:
providing in each case a defined region Bₙ within the respective working region ABₙ for the active elements WEₙ; and
carrying out the collision monitoring for the active elements WEₙ only when the respective active elements WEₙ are located outside of the assigned region Bₙ, and deactivating the collision monitoring for the active elements WEₙ when the respective active elements WEₙ are located at least partly within the assigned region Bₙ.

2. The method according to claim 1, wherein the robot gripper is a parallel jaw gripper with two active elements WE_{n=1,2}, wherein:
a common working region AB of the two active elements WE_{n=1,2} and a common region B are defined by respective spacing ranges that indicate spacings A of the active elements WE_{n=1,2} from one another;
the common working region AB comprises all spacings A of the active elements WE_{n=1,2} from a minimum spacing A_{MIN} to a maximum spacing A_{MAX}, which the active elements WE_{n=1,2} are capable of assuming in each case with respect to one another;
the region B comprises all spacings A of the active elements WE_{n=1,2} from A_{MIN} to a specified spacing A_{B}, wherein: A_{MIN}≤A<A_{B} or A_{MIN}≤A≤A_{B} and A_{B}<A_{MAX}; and
a collision monitoring for the active elements WE_{n=1,2} is carried out only when the active elements WE_{n=1,2} have a spacing A> or ≥AB_{B}.

3. The method according to claim 1, wherein the collision monitoring occurs based on a specified dynamic model of the robot gripper.

4. The method according to claim 1, wherein the collision monitoring occurs using a disturbance variable observer, wherein the disturbance variable observer is a performance observer, a pulse observer, a speed observer, or an acceleration observer.

5. The method according to claim 1, wherein the sensor system, using a position sensor, ascertains a position q_{AE} of the drive unit AE and/or, using a position sensor, ascertains a position q_{AS} of the powertrain AS and/or, using a speed sensor, ascertains a drive unit speed \dot{q}_{AE} of the drive unit AE and/or, using a speed sensor, ascertains a powertrain speed \dot{q}_{AS} of the powertrain AS and/or, using a torque sensor, ascertains a torque τ_{AE} of the drive unit AE and/or, using a torque sensor, ascertains a torque τ_{AS} in the powertrain AS and/or, using a current sensor, ascertains a motor current I_{M} of the drive unit AE.

6. The method according to claim 5, wherein, for the collision monitoring, one or more of following measured variables: q_{AE}, q_{AS}, \dot{q}_{AE}, \dot{q}_{AS}, τ_{AE}, τ_{AS}, and I_{M} are used.

7. The method according to claim 1, wherein the specified operation is selected from the following:
stopping the drive unit AE;
actuating the drive unit AE for gravity compensation;
actuating the drive unit AE for friction compensation in the drive unit AE powertrain AS system;
actuating the drive unit AE in such a manner that a controlled continuous moving apart of the active elements WEₙ occurs; and
actuating the drive unit AE in such a manner that a reflex-like moving apart of the active elements WEₙ occurs.

8. The method according to claim 1, wherein the defining of the regions Bₙ within the working regions ABₙ occurs by a manual or automated teach-in process on the robot gripper, the teach-in process comprising:
gripping an object in such a manner that each of the active elements WEₙ mechanically contacts the object, wherein the region enclosed in the process by the active elements WEₙ defines regions AGₙ;
ascertaining the regions Bₙ, in that the regions AGₙ are widened outwardly by specified delta regions ΔBₙ, so that: Bₙ=AGₙ+ΔBₙ; and
storing Bₙ.

9. A robot gripper comprising:
at least one drive unit AE to drive a powertrain AS with a number N of active elements WEₙ, wherein the active elements WEₙ each have working regions ABₙ arranged in a body-fixed manner relative to the robot gripper, the active elements WEₙ being moveable in and capable of reaching the working regions;
a control unit to control the at least one drive unit AE in closed loop and open loop manner; and
a sensor system connected to the control unit to ascertain forces/moments F_{ext,WEn}(t), where n=1, 2, . . . , N and N≥1, applied externally to the individual active elements WEₙ;
wherein the control unit is designed and configured such that:
a collision monitoring is capable of being carried out for the active elements WEₙ;
the collision monitoring for the active elements WEₙ is carried out only when the respective active elements WEₙ are located outside of a specified assigned region Bₙ located within the working region ABₙ;
the collision monitoring for the active elements WEₙ is deactivated, when the respective active elements WEₙ are located at least partially within the assigned region Bₙ; and
in an event of a detected collision event for an active element WEₙ, the drive unit is actuated according to a specified operation.

10. The robot gripper according to claim 9, wherein the sensor system comprises: a position sensor to ascertain a position q_{AE} of the drive unit AE and/or a position sensor to ascertain a position q_{AS} of the powertrain AS and/or a speed sensor to ascertain a drive unit speed \dot{q}_{AE} of the drive unit AE and/or a speed sensor to ascertain a powertrain speed \dot{q}_{AS} of the power train AS and/or a torque sensor to ascertain a torque τ_{AE} of the drive unit AE and/or a torque sensor to ascertain a torque τ_{AS} in the drive strand of the powertrain AS and/or a current sensor to ascertain a motor current I_{M} of an electric motor of the drive unit AE.

11. The robot gripper according to claim 9, wherein the drive unit AE is a motor coupled via a transmission to the powertrain AS, and a torque sensor to ascertain a torque τ_{AS} in the powertrain AS is connected between the transmission and the powertrain AS.

12. A robot or a humanoid with a robot gripper according to claim 9.
